(19) United States
(12) Patent Application Publication
(10) Pub. No.: US 2021/0317805 A1
(43) Pub. Date: Oct. 14, 2021

(54) INTAKE DEVICE OF ENGINE AND ASSEMBLING METHOD OF THE SAME

(71) Applicant: MAZDA MOTOR CORPORATION, Hiroshima (JP)

(72) Inventors: Jiro KATO, Aki-gun (JP); Taichi MASUOKA, Aki-gun (JP); Yuichi TANIGUCHI, Aki-gun (JP); Taketoshi YAMAUCHI, Aki-gun (JP); Hirofumi SHINOHARA, Aki-gun (JP); Akito KUMAMOTO, Aki-gun (JP); Takashi MIYAMOTO, Aki-gun (JP); Tatsuhiro ISHIDA, Aki-gun (JP)

(73) Assignee: MAZDA MOTOR CORPORATION, Hiroshima (JP)

(21) Appl. No.: 17/190,077

(22) Filed: Mar. 2, 2021

(30) Foreign Application Priority Data
Apr. 14, 2020 (JP) 2020-072355

(51) Int. Cl. F02M 26/30; F02M 26/32

(52) U.S. Cl. CPC F02M 26/30; F02M 26/21; F02M 26/32

(57) ABSTRACT

An EGR system comprising at least one of an EGR cooler and an EGR valve is arranged above an intake manifold. A pair of facing surfaces which face each other with a space are provided at the EGR system attached to the intake manifold and the intake manifold. A damper plate having elasticity is arranged between these facing surfaces. The damper plate is configured to have a larger thickness than the above-described space and have a smaller Young's modulus than each of a lower-side facing-surface portion and an upper-side facing-surface portion, and the damper plate is clamped between the lower-side facing-surface portion and the upper-side facing-surface portion.

### BACKGROUND OF THE INVENTION

The present invention relates to an intake device of an engine which performs EGR and a assembling method of the same.

A technology that part of exhaust gas (EGR gas) is recirculated into intake air in an engine which drives a vehicle, i.e., a so-called EGR (Exhaust Gas Recirculation), is known. An EGR system to perform the EGR comprises an EGR cooler to cool the EGR gas having the high temperature, an EGR valve to adjust the amount of flow of the EGR gas, and others. This EGR system is generally arranged near the engine.

In an engine disclosed in Japanese Patent Laid-Open Publication No. 2016-102429, for example, the EGR valve and the EGR cooler are attached to an upper portion of an intake manifold.

Specifically, the EGR cooler is fixed to the upper portion of the intake manifold made of synthetic resin by bolt joining. The EGR valve is fixed to a one-end portion of the EGR cooler. Thus, the EGR valve is supported at the EGR cooler in a cantilevered state.

In an engine operation, there occurs radiation noises from the intake manifold which is caused by flowing of the intake air. In order to suppress such radiation noises, plural reinforcing ribs provided to project upwardly are generally formed on a surface of the intake manifold so as to increase its strength and rigidity, which is recognized in the engine disclosed in the above-described patent document.

The engine is disposed in an engine room of the vehicle. In general, a bonnet (engine hood) covers over the engine room. It is necessary that a gap having a specified distance or larger is secured between the engine and the bonnet so that appropriate deformation of the bonnet is allowed and thereby collision impact is reduced in a vehicle collision.

Herein, in a case where the EGR system is arranged at the upper side of the intake manifold like the engine disclosed in the above-described patent document, it is required that the EGR system is arranged above the reinforcing ribs provided to project upwardly in order to avoid improper interference of the EGR system with the intake manifold.

Therefore, the arrangement level (height) of the EGR system is high, so that the gap between the EGR system and the bonnet covering over the EGR system becomes narrow. In particular, in a case where the EGR valve is supported in the cantilevered state like the engine disclosed in the above-described patent document, the EGR valve tends to move vertically. Accordingly, the EGR system needs to be arranged at the higher level, so that the above-described gap becomes narrower.

There is a case where the bonnet is arranged at a low level for the purpose of improving the vehicle traveling performance, the superior external appearance, and the like. In this case, the gap between the EGR system and the bonnet covering over the EGR system becomes further narrow. Consequently, it becomes difficult to secure the gap having the specified distance or larger.

It may be suppressed that the gap becomes improperly narrow if the amount of projection of the reinforcing ribs is made small or the ribs are not provided. In these cases, however, the rigidity of the intake manifold may be deteriorated. Thereby, it may become difficult to suppress the radiation noises generated from the intake manifold.

### SUMMARY OF THE INVENTION

Accordingly, a main object of the present invention is to provide an intake device of a vehicle which can secure the necessary and sufficient gap below the bonnet and also suppress the radiation noises of the intake manifold effectively.

The present invention is an intake device of an engine which is installed to a vehicle, comprising an intake manifold attached to an upper portion of an engine body including a cylinder block and a cylinder head which is provided on an upward side of the cylinder block and introducing intake air into the engine body, and an EGR system comprising at least one of an EGR cooler and an EGR valve, the EGR cooler being configured to cool EGR gas recirculated from an exhaust passage of the engine to the intake manifold, the EGR valve being configured to adjust the amount of flow of the EGR gas, wherein the EGR system is arranged at a specified position above the intake manifold, a pair of facing surfaces which face each other with a specified space are provided at a lower portion of the EGR system attached to the intake manifold and an upper portion of the intake manifold, a damper plate having elasticity is arranged between the pair of facing surfaces, the damper plate is configured to have a larger thickness than the space and have a smaller Young's modulus than each of a lower-side facing-surface portion of the intake manifold and an upper-side facing-surface portion of the EGR system which respectively the pair of facing surfaces, and the damper plate is clamped between the lower-side facing-surface portion of the intake manifold and the upper-side facing-surface portion of the EGR system.

That is, the engine performs the EGR by recirculating the EGR gas to the intake manifold. Therefore, the intake device of the engine comprises the EGR cooler and the EGR valve. Herein, the EGR system which corresponds to the EGR cooler, the EGR valve, or both of the EGR cooler and the EGR valve is arranged above the intake manifold.

Further, the facing surfaces are provided at the lower portion of the EGR system (upper-side facing-surface portion) and the upper portion of the intake manifold (lower-side facing-surface portion). When the EGR system is attached to the intake manifold, these facing surfaces face each other with the space having the specified distance. The damper plate having the elasticity is arranged between these facing surfaces.

Moreover, the damper plate has the larger thickness than the space and has the smaller Young's modulus than each of the lower-side facing-surface portion of the intake manifold and the upper-side facing-surface portion of the EGR system. By attaching the EGR system to the intake manifold by using the damper plate, the damper plate is clamped, in a state where the damper plate is compressed and deformed, between the lower-side facing-surface portion of the intake manifold and the upper-side facing-surface portion of the EGR system.

Consequently, the EGR system and the intake manifold are made to contact each other tightly with a relatively-large contact area and integrated. The EGR system is supported at the intake manifold stably. Thus, the strength and rigidity of the intake manifold is increased without reinforcing the intake manifold by means of the ribs. Accordingly, the radiation noises can be suppressed effectively. Tightly clamping of the damper plate can make a situation where the amount of projection of the ribs is small or no rib is provided. Accordingly, it can be suppressed that the gap between the EGR system and the bonnet becomes improperly narrow as well.

In an embodiment of the present invention, plural reinforcing ribs are formed on a surface of a part of the intake manifold which is positioned around the lower-side facing-surface portion of the intake manifold, and the lower-side facing-surface portion of the intake manifold is configured to be a smooth surface with no rib.

Since the lower-side facing-surface portion where the EGR system is arranged is the smooth surface with no rib, the level of the EGR system can be made low effectively. The gap between the EGR system and the bonnet becomes larger, so that the sufficient gap can be secured below the bonnet. Meanwhile, the reinforcing ribs are formed on the surface of the part of the intake manifold which is positioned around the lower-side facing-surface portion of the intake manifold. The sufficient strength and rigidity of the intake manifold can be secured by the ribs. Accordingly, the strength and rigidity can be secured sufficiently by a large part of the intake manifold. Consequently, the radiation noises can be suppressed further effectively.

In another embodiment of the present invention, a lower surface of the upper-side facing-surface portion of the EGR system is formed in an uneven (concave-convex) shape, and an upper surface of the damper plate is formed in an uneven shape which is fit into the uneven shape of the lower surface of the upper-side facing-surface portion of the EGR system.

If the lower-side facing-surface portion is a smooth surface, there is no mark to arrange the damper plate. Therefore, it is difficult to arrange the damper plate properly in an attachment. Meanwhile, if the upper surface of the damper plate is configured to be fit into the uneven shape of the lower surface of the upper-side facing-surface portion, the damper plate can be arranged at a specified position easily and properly.

In another embodiment of the present invention, the space is smaller than a height of the rib.

The greater the height of the rib is, the more the strength and rigidity of a portion of the intake manifold which is reinforced by the rib is increased. The smaller the space is, the more the damper plate is compressed and the more the EGR system and the intake manifold are made to contact tightly. Accordingly, the strength and rigidity of a portion of the intake manifold which is not reinforced by the rib is increased as well. Further, the level of the RGR system becomes further lower. Consequently, the gap between the EGR system and the bonnet is enlarged further, so that the sufficient gap can be secured below the bonnet.

In another embodiment of the present invention, the EGR system is attached to the intake manifold by fastening of plural fastening portions, the plural fastening portions include a first fastening portion, a second fastening portion which is further separated from the engine body than the first fastening portion, and a third fastening portion which is closer to the engine body than the second fastening portion and laterally offset from a longitudinal direction on which the first fastening portion and the second fastening portion align, and a central portion of the damper plate is positioned in an area which is enclosed by the first fastening portion, the second fastening portion, and the third fastening portion.

The strength and rigidity of the first fastening portion which is close to the engine body is relatively high. Meanwhile, the strength and rigidity of the second fastening portion which is far from the engine body is relatively low. The strength and rigidity of a portion of the intake manifold which is separated from the engine body can be increased by fastening the two points of the first and second fastening portions. Further, since a support force can be dispersed efficiently by fastening the third fastening portion which is laterally separated from these two points, the strength and rigidity of the intake manifold can be further increased.

Moreover, by positioning the central portion of the damper plate in the area enclosed by the three points of the first, second, and third fastening portions, a tightly-compressing force can be applied to a wide range of the damper plate. Thereby, the radiation noises can be suppressed more effectively.

In another embodiment of the present invention, the intake manifold comprises an upstream portion which extends in the longitudinal direction at a position which is separated from a side face of the engine body and a downstream portion which expands in a lateral direction from an upper end part of the upstream portion and is attached to the side face of the engine body, an intercooler to the intake air is arranged in a space below the downstream portion, and the lower-side facing-surface portion of the intake manifold is provided at a position of the downstream portion which is separated from the engine body.

The intake device can be made compact by arranging the intercooler in the space below the downstream portion. Further, the intake manifold and the intercooler can be integrated as a unit. Thereby, the storage performance into the engine room and the assembling workability to the engine body can be improved.

The further the intake manifold is from the engine body, the lower the strength and rigidity of the intake manifold is. That is, the radiation noises tend to occur easily. Herein, by providing the lower-side facing-surface portion at the position of the downstream portion which is separated from the engine body, the strength and rigidity of the intake manifold can be increased effectively. Accordingly, the radiation noises can be suppressed effectively.

In another embodiment of the present invention, the EGR system is the EGR valve, the EGR valve comprises a valve body to adjust the amount of flow of the EGR gas by opening/closing of the valve and a valve adapter which has a flow passage where the EGR gas flowing out of the valve body is introduced and is integrated with the valve body and attached to the intake manifold, and the upper-side facing-surface portion of the EGR system is constituted by a lower portion of the valve adapter.

In this intake device, the EGR valve is specified as the above-described EGR system. The EGR valve comprises the valve adapter which serves as an attachment member and a pipe member for the valve body, and the lower portion of the valve adapter constitutes the upper-side facing-surface portion. According to this intake device, EGR introduction from the EGR valve to the intake manifold becomes possible just by attaching the EGR valve to the intake manifold. Accordingly, the intake device can be compact and the storage performance into the engine room can be improved.

The present invention further relates to an assembling method of an intake device of an engine installed to a vehicle, in which an engine body of the engine includes a cylinder block and a cylinder head which is provided on an upward side of the cylinder block and an EGR system comprising at least one of an EGR cooler and an EGR valve is attached to a specified position above an intake manifold attached to the cylinder head of the engine, the assembling method comprising an arrangement step of arranging a damper plate in a space which is formed between a lower-side facing-surface portion provided at an upper portion of the intake manifold and an upper-side facing-surface portion provided at the EGR system which face each other when the EGR system is attached to the intake manifold, wherein the damper plate is configured to have a larger thickness than the space and have a smaller Young's modulus than each of the lower-side facing-surface portion of the intake manifold and the upper-side facing-surface portion of the EGR system, and a clamping step of clamping the damper plate between the lower-side facing-surface portion of the intake manifold and the upper-side facing-surface portion of the EGR system by attaching the EGR system to the intake manifold.

According to the present assembling method of the intake device, the damper plate is arranged between the respective facing surfaces of the EGR system and the intake manifold, and then the EGR system is attached to the intake manifold. Thereby, the damper plate is clamped. Accordingly, the damper plate is compressed and made to contact both of the EGR system and the intake manifold tightly in a wide range. The EGR system and the intake manifold are integrated via the damper plate.

Accordingly, the EGR system is stably supported at the intake manifold. The strength and rigidity of the intake manifold is so increased that the radiation noises can be effectively suppressed. Since the amount of projection of the ribs can be made small or no rib can be required, the gap between the EGR system and the bonnet can be suppressed from being narrow.

In an embodiment of the present assembling method of the intake device, the EGR system is attached to the intake manifold by fastening of plural fastening portions, the plural fastening portions include a first fastening portion, a second fastening portion which is further separated from the engine body than the first fastening portion, and a third fastening portion which is closer to the engine body than the second fastening portion and laterally offset from a longitudinal direction on which the first fastening portion and the second fastening portion align, and the damper plate is arranged in the arrangement step such that a central portion of the damper plate is positioned in an area which is enclosed by the first fastening portion, the second fastening portion, and the third fastening portion.

By fastening the first fastening portion which is provided at the portion having the high strength and rigidity and the second fastening portion which is provided at the portion having the low strength and rigidity, the strength and rigidity of the intake manifold can be increased. Further, by fastening the third fastening portion which is laterally separated from the two points of the first and second fastening portions, the strength and rigidity of the intake manifold can be further increased.

Further, by arranging the central portion of the damper plate in the area enclosed by the three points of the first, second, and three fastening portions, the tightly-compressing force can be applied to the wide range of the damper plate.

The present invention will become apparent from the following description which refers to the accompanying drawings.

### BRIEF DESCRIPTION OF THE DRAWINGS

FIG. 1 is a schematic perspective view of a major part of an intake device of an engine, when viewed from an obliquely front side.

FIG. 2 is a schematic sectional view taken along line Y1-Y1 of FIG. 1.

FIG. 3 is a schematic view of the major part of the intake device of the engine, when viewed from an upper side, wherein an internal structure of an engine body is shown briefly.

FIG. 4A is a schematic upper view of an EGR valve.

FIG. 4B is a schematic lower view of the EGR valve.

FIG. 4C is a schematic side view of the EGR valve.

FIG. 5 is a schematic enlarged perspective view of an upper portion of an intake manifold.

FIG. 6 is an explanatory diagram of attaching of the EGR valve to the intake manifold.

FIG. 7 is a schematic diagram showing a state where a damper plate is arranged on a lower-side facing-surface portion.

FIG. 8A is a schematic enlarged sectional view of the major part of FIG. 2.

FIG. 8B is a schematic sectional view taken along line Y2-Y2 of FIG. 8A.

FIG. 9 is a graph showing an example of results of verification tests relating to suppression of radiation noises.

### DETAILED DESCRIPTION OF THE INVENTION

Hereafter, an embodiment of the present invention will be described. Herein, the following description relates to just an example and does not limit applications or usages of the present invention.

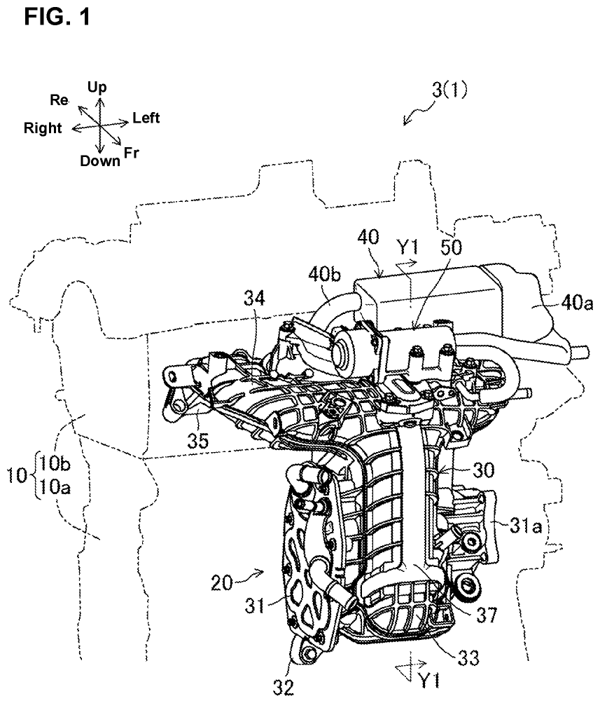

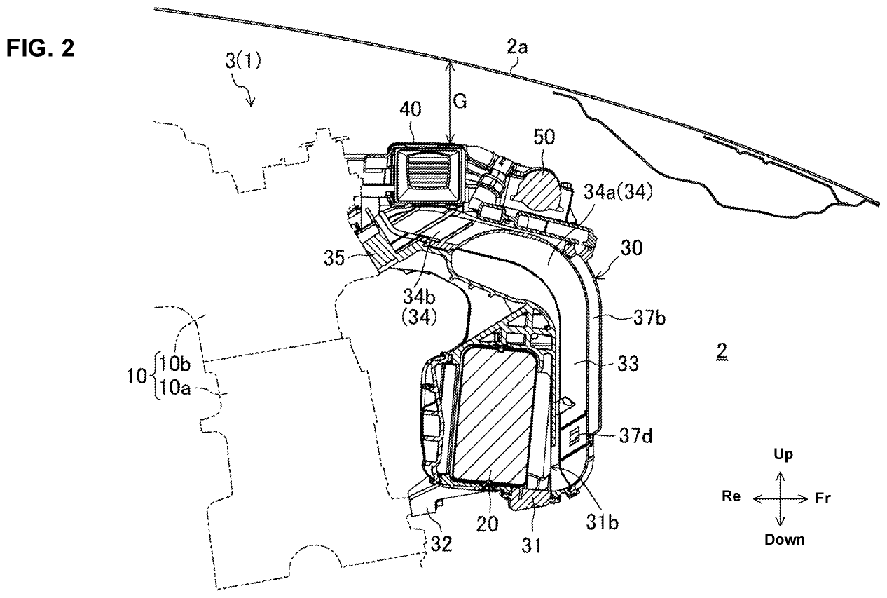

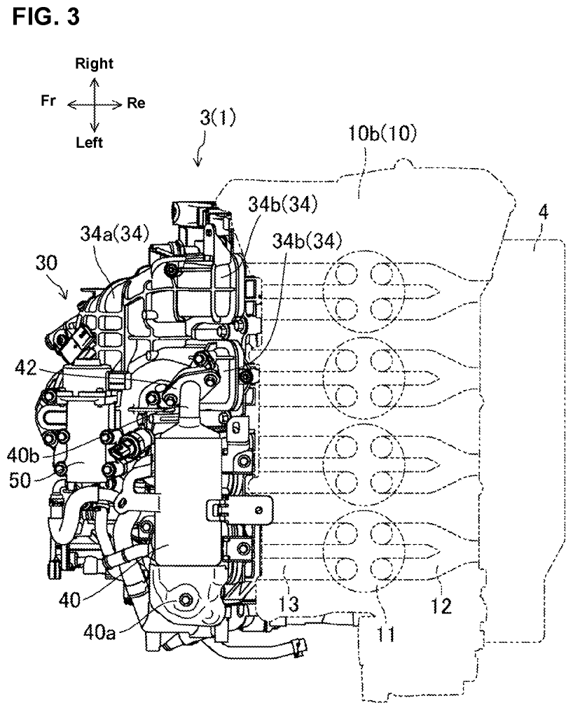

FIG. 1 is a schematic perspective view of a major part of an intake device of an engine, when viewed from an obliquely front side. FIG. 2 is a schematic sectional view taken along line Y1-Y1 of FIG. 1. FIG. 3 is a schematic view of the major part of the intake device of the engine, when viewed from an upper side.

As shown in these figures, an intake device 3 is integrated with an engine (these may be referred to as “engine 1” comprehensively). Herein, arrows indicated in the figures show “longitudinal,” “lateral,” and “vertical” directions which are used in the flowing description. Further, “upstream” and “downstream” which are used in the following description are based on a flow direction of the fluid.

[Engine 1]

The engine 1 is installed to a four-wheel automobile as a driving source. As shown in FIG. 2, the engine 1 is stored into an engine room 2 which is arranged in front of a cabin of the automobile. The engine 1 is covered with a bonnet (engine hood) 2a. It is necessary that a gap G between the engine 1 and the bonnet 2a has a specified distance or larger so that the bonnet 2a is deformed and thereby collision impact is reduced in a vehicle collision. The engine 1 of the present embodiment is configured such that this gap G is secured by suppressing the overall level (overall height) of the engine 1 including an intake device 3.

The automobile travels by means of the engine 1 which is driven according to a driver's operation. In the engine 1, air mixture containing gasoline is burned in plural combustion chambers 11 which will be described later. This engine 1 is a four-stroke type of engine which repeats an intake stroke, a compression stroke, an expansion stroke, and an exhaust stroke.

The intake device 3 introduces intake air into the respective combustion chambers 11 according to these combustion cycles. As shown in FIGS. 1 and 3, a major part of the intake device 3 is arranged in front of the engine 1. The engine 1 is further provided with an exhaust device 4 to discharge exhaust gas from the combustion chambers 11. A major part of the exhaust device 4 is arranged in back of the engine 1 as shown in FIG. 3 only.

<Engine Body 10>

As shown in FIGS. 1 and 2, the engine 1 comprises an engine body 10 which includes a cylinder block 10a, a cylinder head 10b, and so on. The cylinder head 10b is attached onto the cylinder block 10a. The cylinder head 10b constitutes an upper part of the engine body 10, and the cylinder block 10a constitutes a lower part of the engine body 10. As shown in FIG. 3, the plural combustion chambers 11 are provided at the engine body 10. The exemplified engine 1 has the four combustion chambers 11, which is the so-called four-cylinder engine.

The four combustion chambers 11 are arranged in line along an extension direction of a crankshaft, not illustrated, (a direction of an output shaft). The engine body 10 has an elongated shape where the length, in the output-shaft direction, of the engine body 10 is longer. The engine body 10 is laterally disposed in the engine room 2 such that its output-shaft direction substantially matches a vehicle width direction (lateral direction).

Four cylinders are formed at the cylinder block 10a. A piston to conduct a reciprocating movement is provided in each cylinder. A lower face of the cylinder is closed with the piston. An upper face of the cylinder is closed with the cylinder head 10b. The combustion chamber 11 is partitioned by the cylinder block 10a, the piston, and the cylinder head 10b inside the engine body 10.

As shown in FIG. 3, an exhaust port 12 is formed at a rear-side portion of the cylinder head 10b such that it connects to each of the combustion chambers 11. The exhaust port 12 is opened or closed by an exhaust valve in accordance with combustion inside the combustion chamber 11. Exhaust gas generated by the combustion inside each of the combustion chambers 11 is discharged to the exhaust device 4 through the respective exhaust ports 12.

The exhaust device 4 comprises an exhaust manifold, an exhaust purification device, a silencer, and so on, which are not illustrated. The exhaust gas generated inside each of the combustion chambers 11 is purified by the exhaust device 4 and then exhausted to the outside from a rear portion of the automobile.

As shown in FIG. 3, an intake port 13 is formed at a front-side portion of the cylinder head 10b such that it connects to each of the combustion chambers 11. The intake port 13 is opened or closed by an intake valve in accordance with the combustion inside the combustion chamber 11. An inlet of each of the intake ports 13 is opened to a front-side face of the cylinder head 10b. The intake device 3 is attached to a front side of the engine body 10 such that the intake air is introduced into each of the combustion chambers 11 through the inlet of the intake port 13.

[Intake Device 3]

As shown in FIG. 1, the intake device 3 comprises an intercooler 20, an intake manifold 30, and so on. These components are arranged at specified positions of an intake passage where the intake air flows. The intake device 3 further comprises an EGR cooler 40, an EGR valve 50, and others.

That is, the engine 1 performs the EGR by recirculating part of the exhaust gas discharged from each of the combustion chambers 11 as EGR gas. Accordingly, the intake air introduced into the combustion chamber 11 may contain the EGR gas in addition to fresh air (air). These components are arranged at specified positions of an EGR passage where the EGR gas flows.

In particular, in a case of the engine 1, the EGR cooler 40 and the EGR valve 50 are arranged at the respective positions above the intake manifold 30. In the present embodiment, the EGR valve 50 corresponds to an “EGR system” of the invention.

A throttle valve, not illustrated, is arranged at an upstream side in the intake passage. The throttle valve adjusts the amount of vehicle-outside air (fresh air) taken into the intake manifold. Further, a supercharger (turbocharger) to perform supercharging is arranged at the engine 1.

The supercharger is arranged at a position in the intake passage which is located downstream of the throttle valve. The supercharger supercharges the intake air flowing down in the intake passage by using flowing of the exhaust gas so that a downstream-side pressure inside the intake passage becomes higher than an upstream-side pressure inside the intake passage. Herein, this supercharger may be a mechanical type which is driven by the engine or a motor.

The intercooler 20 is a water-cooling type of cooling device where heat exchange with cooling water circulated therein is performed. The intercooler 20 is arranged at a position of the intake passage which is located downstream of the supercharger. The intercooler 20 cools the intake air, temperature of which is increased by the supercharging.

As shown in FIGS. 1 and 2, the intercooler 20 is arranged in front of the front-side face of the engine body 10. The intercooler 20 is formed integrally with the intake manifold at the engine 1.

<Intake Manifold 30>

Since it introduces the intake air into the engine body 10, the intake manifold 30 is attached to the upper portion of the engine body 10, that is, to the front-side face of the cylinder head 10b. The intake manifold 30 is made of synthetic resin. That is, the intake manifold 30 is made by joining plural synthetic-resin made parts. The intake manifold 30 comprises a cooler unit portion 31, an upstream portion 33, and a downstream portion 34.

The cooler unit portion 31 forms an outline portion of the intercooler 20. That is, the cooler unit portion 31 is formed by a case-shaped portion which is sealed and has a large volume. A lower-side attaching bracket 32 is provided at a lower part of the cooler unit portion 31. A water-cooling type of heat exchanger is stored inside the cooler unit portion 31. Thus, since a relatively-large heat exchanger can be disposed, the intercooler 20 which has the superior cooling performance can be provided.

As shown in FIG. 1, an intake-air introduction inlet port 31a is provided at a left end part of the cooler unit portion 31 such that this port 31a connects to an inside of the cooler unit portion 31. As shown in FIG. 2, an intake-air introduction outlet port 31b is provided at a front side of a lower end part of the cooler unit portion 31 such that this port 31b connects to the cooler unit portion 31. The intake air is taken in to the cooler unit portion 31 and taken out of the intake-air introduction outlet port 31b. The intake air introduced into the cooler unit portion 31 flows to the right inside the cooler unit portion 31 and then passes through the heat exchanger. Herein, the heat of the intake air is released to the cooling water, whereby the intake air is cooled.

The upstream portion 33 is formed by a cylindrical portion extending in a longitudinal direction. The lateral width of the upstream portion 33 is considerably smaller than the length of the front-side face of the cylinder head 10b. The upstream portion 33 is formed integrally with a front part of the cooler unit portion 31. An upper end portion of the upstream portion 33 is located at the higher level than the cooler unit portion 31.

A lower end part of the upstream portion 33 connects to the intake-air introduction outlet port 31b. Thereby, the intake air passing through the cooler unit portion 31 flows into the upstream portion 33. The intake air flows upwardly from a lower side of the upstream portion 33. The upstream portion 33 forms an intake passage which is positioned downstream of the intercooler 20.

The downstream portion 34 is formed by a cylindrical portion extending in a lateral direction from the upper end portion of the upstream portion 33. The lateral width of the downstream portion 34 is substantially the same length as the length of the front-side face of the cylinder head 10b. The downstream portion 34 comprises an enlarged part 34a and four branch parts 34b so that the homogeneous intake air can be distributed as shown in FIGS. 2, 3 and 5.

The enlarged part 34a has substantially the same lateral width as the length of the front-side face of the cylinder head 10b and formed integrally with the upstream portion 33. The upper end portion of the upstream portion 33 connects to a central position of the front side of the enlarged part 34a. An inside of the enlarged part 34a connects to an inside of the upstream portion 33. Accordingly, the intake air flowing through the upstream portion 33 flows into the enlarged part 34a. The enlarged part 34a forms an intake-air flow passage where the lateral width of the intake passage is enlarged suddenly.

Each of the branch parts 34b is formed in a cylindrical shape having a narrow lateral width. Respective one ends of the branch parts 34b are continuous to a rear side of the enlarged part 34a such that these are arranged laterally in line. The other ends of the branch parts 34b are formed integral with an upper-side attaching bracket 35 which has a laterally-long shape. Each inside of the branch parts 34b connects to an inside of the enlarged part 34a. Accordingly, the intake air flowing into the enlarged part 34a flows into the respective branch parts 34b.

As shown in FIG. 2, the intake manifold 30 is attached to the engine body 10 via the upper-side attaching bracket 35 and the lower-side attaching bracket 32. The lower-side attaching bracket 32 is fastened to a boss of the cylinder block 10a. The upper-side attaching bracket 35 is fastened to the front-side face of the cylinder head 10b.

Thus, the respective branch parts 34b connect to the respective intake ports 13 through the respective inlets. The branch parts 34b constitute the intake passage to distribute the intake air to the respective intake ports 13.

Further, the intercooler 20 is arranged in a space below the downstream portion 34. Thus, the intake device 3 can be compact and the intake manifold 30 and the intercooler 20 can be integrated as a unit. The storage performance of these components into the engine room 2 and the workability of these components to the engine body 10 can be improved.

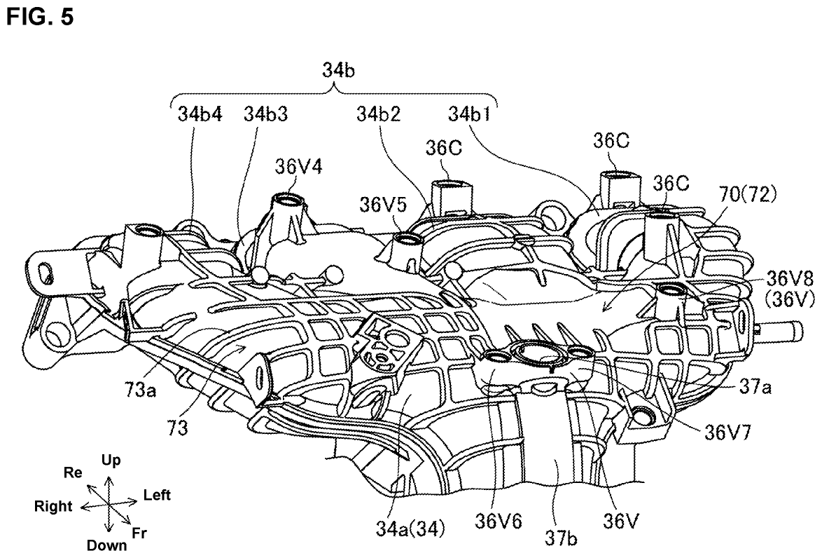

As shown in FIG. 5, the intake manifold 30 is provided with plural fastening boss portions (a boss portion for cooler 36C and a boss portion for valve 36V, which will be described later) for attaching the EGR cooler 40 and the EGR valve 50. Further, the intake manifold 30 is provided with an EGR introduction portion 37 to recirculate the EGR gas thereto as shown in FIG. 1. The plural fastening boss portions 36C, 36V and the EGR introduction portion 37 are formed integrally with the intake manifold 30.

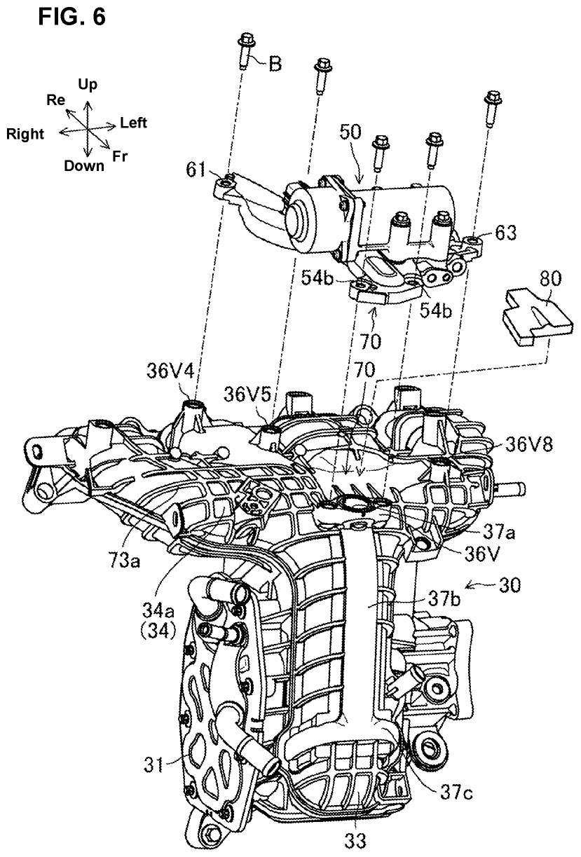

The EGR introduction portion 37 constitutes a passage where the EGR gas flows. The EGR introduction portion 37 includes a vertical passage part 37b and a forked passage part 37c as shown in FIG. 6.

The vertical passage part 37b is formed in a slender tubal-shape, which is provided at a surface of the upstream portion 33. The vertical passage part 37b extends in a vertical direction along a center line of the upstream portion 33 (an imaginary line passing a center, in the lateral direction, of the upstream portion 33). The boss portion for valve 36V which is used for connection to the EGR passage (boss portion for valve connection 36V) is provided at a border section (bent section) of the upstream portion 33 and the downstream portion 34 of the intake manifold 30 which is located at the above-described center line.

An upper end of the vertical passage part 37b is formed integrally with the boss portion for valve connection 36V. That is, a sixth boss portion 36V6 and a seventh boss portion 36V7, which will be described later, are formed integrally with the boss portion for valve connection 36V. Further, a gas introduction inlet port 37a to take in the EGR gas to the vertical passage part 36b is formed between the sixth boss portion 36V6 and the seventh boss portion 36V7.

The forked passage part 37c is continuous to a lower end of the vertical passage part 37b. The forked passage part 37c is also formed in a slender tubal-shape, which is provided at the surface of the upstream portion 33. The forked passage part 37c is configured to be bifurcated in right-and-left both-side direction from the lower end of the vertical passage part 37b. An inside of the vertical passage part 37b connects to an inside of the forked passage part 37c.

The forked passage part 37c is provided with a pair of gas introduction outlet ports 37b. The gas introduction outlet ports 37c are opened at right-and-left both sides of a lower end portion of the upstream portion 33 as shown in FIG. 2. An inside of the forked passage part 37c connects to an inside of the upstream portion 33 through the gas introduction outlet ports 37d.

The plural fastening boss portions comprises the boss portion for cooler 36C to attach the EGR cooler 40 to the intake manifold 30 by bolts B and the boss portion for valve 36V to attach the EGR valve 50 to the intake manifold 30 by bolts B.

The four branch parts 34b comprises, as shown in FIG. 5, a first branch part 34b1, a second branch part 34b2, a third branch part 34b3, and a fourth branch part 34b4, which are disposed in order from the left side, and the boss portion for cooler 36C is provided at three points on upper faces of the first branch part 34b1 and the second branch part 34b2. That is, the boss portion for cooler 36C comprises a first boss portion 36C which is provided at a point of the first branch part 34b1 which is located near the upper-side attaching bracket 35, a second boss portion 36C which is provided at a point of the second branch part 34b2 which is located near the upper-side attaching bracket 35, and a third boss portion 36C which is provided at another point of the first branch part 34b1 which is located near the enlarged part 34a.

Meanwhile, the boss portion for valve 36V comprises first-eighth boss portions, which are provided at five points on upper faces of the third branch part 34b3 and the enlarged part 34a. That is, a fourth boss portion 36V4 is provided at a point of the third branch part 34b3 which is located near the upper-side attaching bracket 35. A fifth boss portion 36V5 is provided at another point of the third branch part 34b3 which is located near the enlarged part 34a. A sixth boss portion 36V6 and a seventh boss portion 36V7 are provided at the boss portion for valve connection 36V as described above. A eighth boss portion 36V8 is provided at a point of the enlarged part 34a which is located near the first branch part 34b1.

The intake manifold 30 is further provided with a reinforcement face portion 73 and a lower-side facing-surface portion 72, which will be described later.

<EGR Cooler 40>

The EGR cooler 40 is made of a laterally-long and flat pole-shaped member. The length of the EGR cooler 40 is smaller than, about a half of, the lateral width of the upstream portion 33. The EGR cooler 40 has a flow-in portion 40a where the EGR gas flows in at its one-end portion and a flow-out portion 40b where the EGR gas flows out at its other-end portion. The EGR cooler 40 is a water-cooling type of heat exchanger which cools the EGR gas through heat exchanging with the cooling water.

The EGR cooler 40 has supporting brackets which correspond to the respective boss portions for cooler 36C. The EGR cooler 40 is attached to the intake manifold 30 by fastening the supporting brackets to the boss portions 36C with bolts. Thus, the EGR cooler 40 is arranged such that the flow-in portion 40a is positioned above the first branch part 34b1 and the flow-out portion 40b is positioned above the third branch part 34b3. As shown in FIG. 3, the flow-out portion 40b is provided with a connecting flange 42 for connection to the EGR valve.

<EGR Valve 50>

The EGR valve 50 is arranged at a position of the EGR passage which is located downstream of the EGR cooler 40. Specifically, as shown in FIGS. 1 and 3, the EGR valve 50 is arranged at an upper side of the intake manifold 30 over an area from the third branch part 34b3 to the enlarged part 34a.

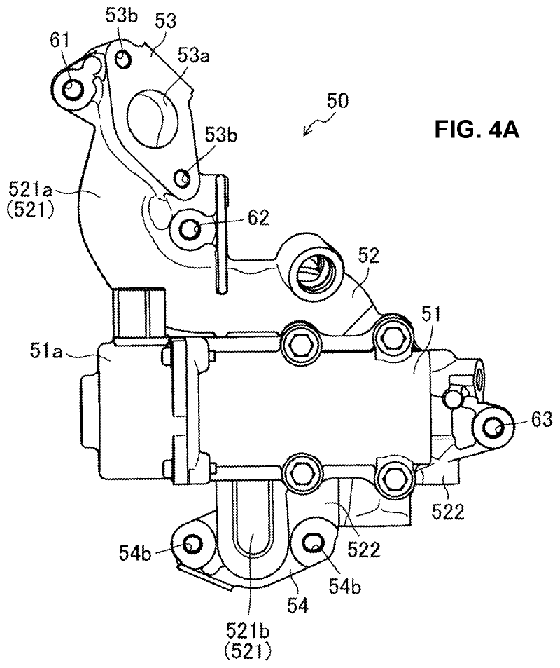

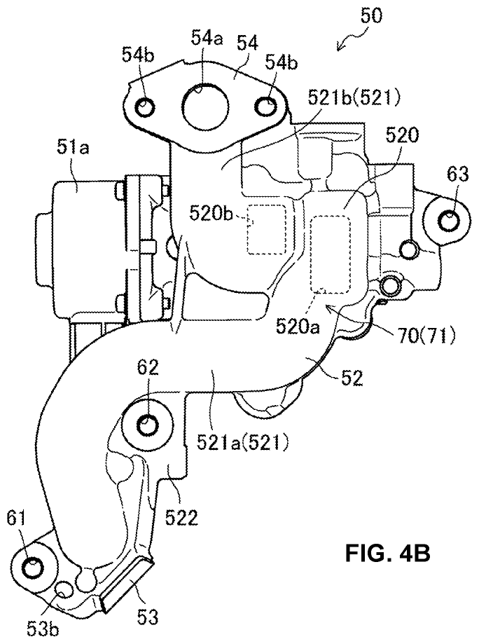

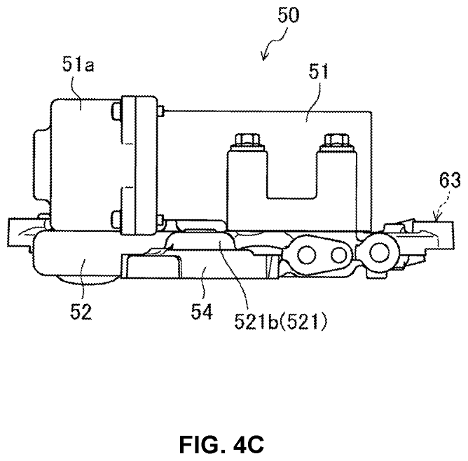

The EGR valve 50 is shown in FIGS. 4A, 4B and 4C. The EGR valve 50 comprises a valve body 51, a valve adapter 52, and others.

The valve body 51 is made of a metal-based parts member. A gas passage provided with a valve which can adjust a valve-opening degree, not illustrated, is formed inside the valve body 51. A gas inlet which connects to a position of the gas passage which is located upstream of the valve and a gas outlet which connects to another position of the gas passage which is located downstream of the valve are opened to a lower face of the valve body 51. A motor 51a to drive the valve so as to control its valve-opening degree is integrally assembled to the valve body 51.

The valve adapter 52 is formed integrally with the valve body 51. The valve adapter 52 is an adapter to support and attach the heavy valve body 51 to the intake manifold 30. The valve adapter 52 also has a flow passage to introduce the EGR gas flowing out of the valve body 51 into the EGR introduction portion 37 of the intake manifold 30, which constitutes a part of the EGR passage. That is, the valve adapter 52 serves as both an attaching member and a piping member for the valve body 51.

The valve adapter 52 comprises a base portion 520, a pipe portion 521, and an expansion portion 522 for attachment to the intake manifold 30. The valve body 51 is attached to an upper face of the base portion 520. An upstream opening 520a and a downstream opening 520b are formed at the upper face of the base portion 520. The upstream opening 520a is connected to the gas inlet of the valve body 51, and the downstream opening 520b is connected to the gas outlet of the valve body 51.

The pipe portion 521 constitutes a flat flow passage where the EGR gas flows. The pipe portion 521 comprises an upstream-side pipe part 521a which has an upstream opening 520a at its one-end portion and a downstream-side pipe part 521b which has a downstream opening 520b at its one-end portion. The upstream-side pipe part 521a extends rearwardly from the valve body 51, curving in a nearly S shape. The downstream-side pipe part 521b extends forwardly from the valve body 51, curving in a nearly L shape.

An upstream-side flange portion 53 where a gas inlet port 53a is opened is provided at the other-end portion of the upstream-side pipe part 521a. A downstream-side flange portion 54 where a gas outlet port 54a is opened is provided at the other-end portion of the downstream-side pipe part 521b. A pair of bolt holes (upstream-side connection holes 53b) which penetrate the upstream-side flange portion 53 are formed at both sides of the gas inlet port 53a of the upstream-side flange portion 53. A pair of bolt holes (downstream-side connection holes 54b) which penetrate the downstream-side flange portion 54 are formed at both sides of the gas outlet port 54a of the downstream-side flange portion 54.

The expansion portion 522 is formed by a portion which expands from specified edges of the base portion 520 and the pipe portion 521. First-third bolt holes which penetrate the expansion portion 522 are formed at specified positions of the expansion portion 522. A first bolt hole 61 is formed at a side position of the upstream-side pipe portion 521a which is located near the upstream-side flange portion 53 and far from the valve body 51. A second bolt hole 62 is formed at a side position of the upstream-side pipe portion 521a which is located near the upstream-side flange portion 53 and close to the valve body 51. A third bolt hole 63 is formed at a side position of the base portion 520.

The EGR valve 50 is attached to the EGR cooler 40 and the intake manifold 30 by fastening the bolts B to the plural fastening points including the boss portion for valve 36V.

Specifically, as shown in FIG. 6, the bolt B inserted into the first bolt hole 61 is fastened to the fourth boss part 36V4. The bolt B inserted into the second bolt hole 62 is fastened to the fifth boss part 36V5. The bolt B inserted into the third bolt hole 63 is fastened to the eighth boss part 36V8. The bolts B inserted into the two downstream-side connection holes 54b are fastened to the sixth boss part 36V6 and the seventh boss part 36V7.

Thus, the EGR valve 50 is connected to the EGR cooler 40 by fastening the bolts B inserted into the two upstream-side connection holes 53b to the connection flanges 42 with nuts. Herein, an attaching method of the EGR valve 50 will be described later.

<Features of Intake Manifold 3>

The intake manifold 3 is a resin-made component as described above. Accordingly, the strength and rigidity of that is not higher than those of a metal-made component. Therefore, the flowing of the intake air causes radiation noises to be generated from the intake manifold 30. If the radiation noises are excessively large, the intake manifold 3 makes improper noises.

Herein, it has been generally done in order to suppress the radiation noises that the plural reinforcing ribs are formed in a lattice shape on the surface of the intake manifold so as to improve the strength and rigidity of the intake manifold. Meanwhile, in a case where the EGR system, such as the EGR cooler 40 or the EGR valve 50, is arranged above the intake manifold 30 like the above-described engine 1, it is required that the EGR system is arranged above ribs 73a which are formed on the upper face of the intake manifold 30.

However, the bonnet 2a exists above the engine 1 as shown in FIG. 2. Thus, it is required that the gap G between the engine 1 and the bonnet 2a has a specified distance or larger so that the bonnet 2a can be properly deformed and thereby the collision impact can be properly reduced in the vehicle collision. Accordingly, the arrangement level (height) of the EGR system has a limit.

Further, the bonnet 2a is inclined such that its front side is located at a lower level than its rear side. Accordingly, the limit of the arrangement level (height) of the EGR system becomes more sever as it goes to the front side.

In particular, in the case of the engine 1, the intercooler 20 is arranged in the space below the downstream portion 34, so that the intercooler 20 is integrated with the intake manifold 30 as the unit. Accordingly, the upstream portion 33 is positioned in front of and separately from the engine body 10. The downstream portion 34 is configured to expand in front of the engine body 10. The EGR cooler 40 and the EGR valve 50 are attached by utilizing a space above the downstream portion 34.

The EGR cooler 40 is attached to a position of the downstream portion 34 which is located near the upper-side attaching bracket 35. The level of the bonnet 2a at this position is relatively high. Accordingly, even if the EGR cooler 40 is attached on the upper face of the intake manifold 30 which is reinforced by the ribs 73a, the sufficient gap G can be secured below the bonnet 2a. Since the strength and rigidity of the intake manifold 30 can be secured by the ribs 73a as well, the radiation noises can be suppressed effectively.

Meanwhile, the EGR valve 50 is arranged at a position of the downstream portion 34 which is located on the forward side of the EGR cooler 40. In particular, the valve body 51 which is located at the highest level in the EGR valve 50 is arranged above the expansion part 34a which is separated from the engine body 10. The level of the bonnet 2a becomes lower at this position. Accordingly, even if the EGR valve 50 is attached on the upper face of the intake manifold 30 which is reinforced by the ribs 73a, there is a concern that the sufficient gap G may not be secured below the bonnet 2a.

Herein, it may be considered that the projection amount of the ribs 73a is made small or the ribs 73a are not formed so as to arrange the EGR valve 50 at a lower level. In these cases, however, the strength and rigidity of the intake manifold 30 are so deteriorated that the suppression of the radiation noises may become difficult. Further, since the enlarged part 34a structurally has the lower strength and rigidity than the branch parts 34b, the radiation noises tend to become higher.

Meanwhile, the present engine 1 is configured such that the securement of the sufficient gap G and the suppression of the radiation noises can be compatible. That is, a pair of facing surfaces 70, 70 are provided between the EGR valve 50 and the intake manifold 30 as shown in FIG. 6. Further, a specified damper plate 80 is arranged between these facing surfaces 70, 70, and this damper plate 80 is clamped between the EGR valve 50 and the intake manifold 30. First, a pair of facing surfaces 70, 70 which face each other with a specified space S are provided at a lower portion (an upper-side facing-surface portion 71) of the EGR valve 50 attached to the intake manifold 30 and an upper portion (a lower-side facing-surface portion 72) of the intake manifold 30.

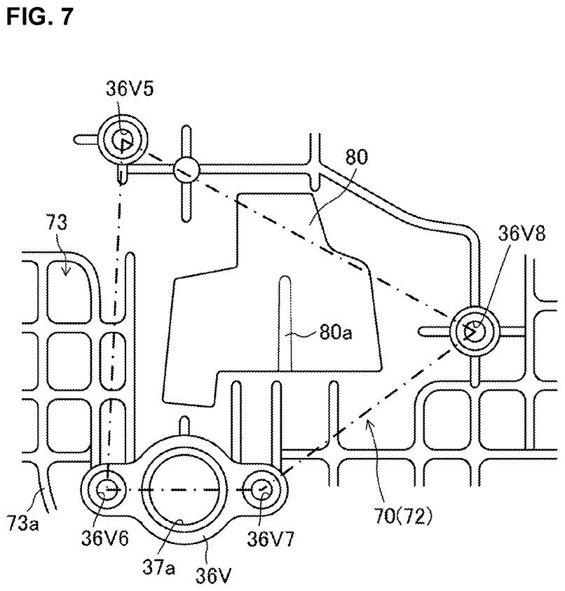

Specifically, as shown in FIGS. 5 and 7, a smooth surface where the ribs 73a are not formed (which is a smooth flat or curved surface) is formed in a specified area of the upper face of the enlarged portion 34a. This smooth surface corresponds to the facing surface 70, and the upper portion of the intake manifold 30 with the smooth surface corresponds to the lower-side facing-surface portion 72. The reinforcing ribs 73a are formed on a surface of a part of the intake manifold 30 which is positioned around the lower-side facing-surface portion 72 (a reinforcement face portion 73). The reinforcement face portion 73 has the higher strength and rigidity than the lower-side facing-surface portion 72 where the ribs 73a are not formed.

The three fastening points for fastening of the EGR valve 50 are arranged at a peripheral part of the lower-side facing-surface portion 72. That is, as shown in FIG. 7, a first fastening point, a second fastening point, and a third fastening point are arranged at the peripheral part of the lower-side facing-surface portion 72. The first fastening point is constituted by the fifth boss part 36V5. The second fastening point is constituted by the sixth boss part 36V6 and the seventh boss part 36V7. The third fastening point is constituted by the eighth boss part 36V8.

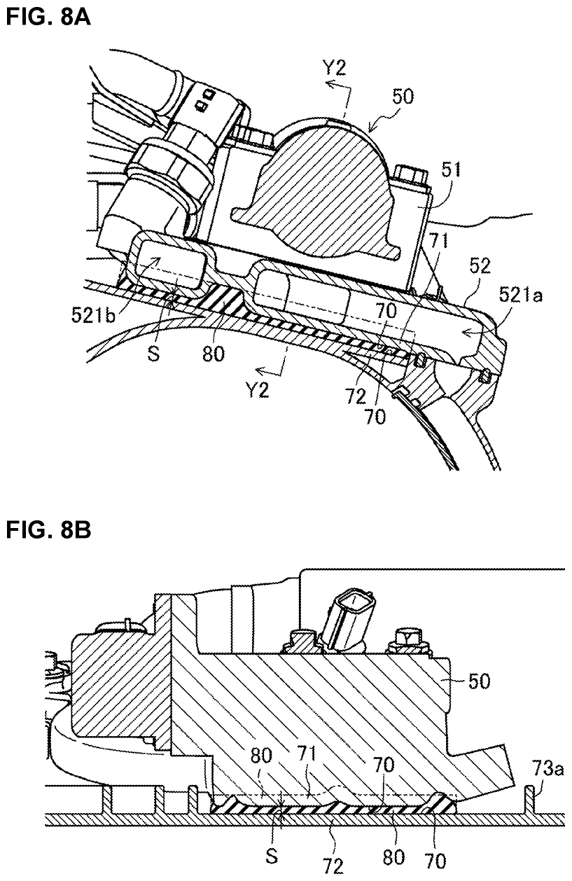

As shown in FIGS. 8A and 8B, in a state where the EGR valve 50 (valve adapter 52) is attached to the above-described fastening points, a specified point of the lower portion of the valve adapter 52 faces the lower-side facing-surface portion 72 with the specified space S. The specified point of the lower portion of the valve adapter 52 corresponds to the upper-side facing-surface portion 71, and the surface of this specified point corresponds to the facing surface 70.

The space S is set to be smaller than the height of the ribs 73a. Thereby, the upper-side facing-surface portion 71 is located below the ribs 73a. Accordingly, the EGR valve 50 can be arranged at a lower level compared to a case where the EGR valve 50 is arranged above the ribs 73a. Even if the position of the bonnet 2a is low, the necessary gap G can be provided below the bonnet 2a easily.

Secondly, the damper plate 80 is arranged between the pair of facing surfaces 70, 70, and the damper plate 80 is clamped between the lower-side facing-surface portion 72 and the upper-side facing-surface portion 71.

The damper plate 80 is made of a plate-shaped member having a specified shape. The damper plate 80 is made of a material having the elasticity, such as synthetic resin. The thickness of the damper plate 80 is set to be larger than the space S. When it is clamped between the lower-side facing-surface portion 72 and the upper-side facing-surface portion 71, the damper plate 80 is compressed, in its thickness direction, from a state shown by a two-dotted line to another state shown by a solid line in FIGS. 8A and 8B.

The damper plate 80 is made of a material which has a smaller Young's modulus (modulus of longitudinal elasticity) than each of the lower-side facing-surface portion 72 and the upper-side facing-surface portion 71. Thereby, the damper plate 80 is deformed greatly when clamped between the lower-side facing-surface portion 72 and the upper-side facing-surface portion 71. Herein, an aligning direction in which the lower-side facing-surface portion 72 and the upper-side facing-surface portion 71 align is defined as the thickness direction of the damper plate, and it is preferable that at least the Young's modulus, in the thickness direction, of the damper plate be smaller than each of the lower-side facing-surface portion 72 and the upper-side facing-surface portion 71.

That is, by arranging the damper plate 80 between the lower-side facing-surface portion 72 and the upper-side facing-surface portion 71 and by attaching the EGR valve 50 to the intake manifold 30, the damper plate 80 is compressed and made to tightly contact the respective facing surfaces 70 of the lower-side facing-surface portion 72 and the upper-side facing-surface portion 71. It is unnecessary that the damper plate 80 is attached to the valve adapter 52 or the intake manifold 30 by an adhesive or the like.

The damper plate 80 is clamped between the lower-side facing-surface portion 72 and the upper-side facing-surface portion 71. Thereby, the EGR valve 50 and the intake manifold 30 are made to contact each other tightly in a relatively-wide range and integrated as the unit.

As a result, the EGR valve 50 is stably supported at the intake manifold 30. Loosening of the respective fastening points can be suppressed because of the performance of an elastic force of the damper plate 80. The enlarged part 34a (the lower-side facing-surface portion 72) is formed integrally with the valve adapter 52 (the upper-side facing-surface portion 71) via the damper plate 80. Thereby, its strength and rigidity can be increased more than the reinforcement by the ribs 73a even if the ribs 73a are not provided. Accordingly, the radiation noises can be suppressed.

The damper plate 80 is formed in a specified shape which matches a shape of the valve adapter 52 and the like. Meanwhile, the surface of the lower-side facing-surface portion 72 is a smooth surface without mark. The damper plate 80 is just clamped between the EGR valve 50 and the intake manifold 30, so that it is difficult that the damper plate 80 is located at a specified position when attached.

Then, the damper plate 80 is formed so as to be fit into the upper-side facing-surface portion 71. Specifically, the lower face of the upper-side facing-surface portion 71 has an uneven (concave-convex) shape in accordance with a shape of the pipe portion 521 and the like as shown in FIG. 4B. Meanwhile, the upper face of the damper plate 80 is provided with a portion (a fitting portion 80a) which is fit into the above-described uneven shape as shown in FIG. 7. The lower face of the damper plate 80 is the smooth surface.

When the damper plate 80 is arranged between the upper-side facing-surface portion 71 and the lower-side facing-surface portion 72, the upper face of the damper plate 80 is fit into the lower face of the upper-side facing-surface portion 71. Thereby, the damper plate 80 can be arranged at the specified position easily and properly.

In a case where the damper plate 80 is arranged at the specified position, the damper plate 80 can be made to tightly contact both the upper-side facing-surface portion 71 and the lower-side facing-surface portion 72 effectively.

Specifically, as shown in FIG. 7, the damper plate 80 is arranged at the specified position such that its central portion is positioned in an area which is enclosed by the first fastening portion (the fifth boss part 36V5), the second fastening portion (the sixth boss part 36V6 and the seventh boss portion 36V7), and the third fastening portion (the eighth boss part 36V8).

As described above, the first fastening portion (the fifth boss part 36V5), the second fastening portion (the sixth boss part 36V6 and the seventh boss portion 36V7), and the third fastening portion (the eighth boss part 36V8) are arranged at the peripheral part of the lower-side facing-surface portion 72. Accordingly, the tightly-compressing force can be applied to the wide range of the damper plate 80 by fastening these fastening portions. Thereby, the radiation noises can be suppressed effectively.

<Assembling Method of Intake Device 3>

Next, in some steps of the assembling method of the intake device 3, a step of attaching the EGR valve 50 to the specified position above the intake manifold 30 will be described. This step primarily comprises an arrangement step and a clamping step.

In the arrangement step, the damper plate 80 is arranged at a position where the upper-side facing-surface portion 71 of the EGR valve 50 and the lower-side facing-surface portion 72 of the intake manifold 30 face each other.

Herein, the upper face of the damper plate 80 is fit into the lower face of the EGR valve 50. Thereby, work mistakes (work errors) where a direction and/or the right side and the wrong side of the damper plate 80 can be prevented. Even if the lower-side facing-surface portion 72 is the surface with no mark, the damper plate 80 can be securely arranged such that its central portion is positioned in the area which is enclosed by the first fastening portion, the second fastening portion, and the third fastening portion.

In the clamping step, the damper plate 80 is clamped between the lower-side facing-surface portion 72 and the upper-side facing-surface portion 71 by attaching the EGR valve 50 to the intake manifold 30.

The bolts B are fastened to the plural fastening portions including the above-described first, second, and third fastening portions in the state where the damper plate 80 is arranged at the specified position. Thereby, the EGR valve 50 is attached to the intake manifold 30.

Specifically, as shown in FIG. 6, the bolt B is inserted into the first bolt hole 61 and then fastened to the fourth boss portion 36V4. The bolt B is inserted into the second bolt hole 62 and then fastened to the fifth boss portion 36V5. The bolt B is inserted into the third bolt hole 63 and then fastened to the eighth boss portion 36V8. Further, the bolts B are inserted into the two downstream-side connection holes 54b and then fastened to the sixth boss portion 36V6 and the seventh boss portion 36V7, respectively.

Herein, it is preferable that the first fastening portion (the fifth boss portion 36V5), the second fastening portion (the sixth boss portion 36V6 and the seventh boss portion 36V7), and the third fastening portion (the eighth boss portion 36V8) be mutually fastened at plural times each. That is, it is preferable that these fastening portions be not fastened at one time each, but be mutually fastened at plural times each by gradually increasing the fastening force until the fastening force reaches a specified value.

Thereby, deviation of the tightly-compressing force applied to the damper plate 80 can be suppressed. Thus, the damper plate 80 can be properly clamped. Consequently, the radiation noises can be suppressed more effectively.

### EXAMPLE

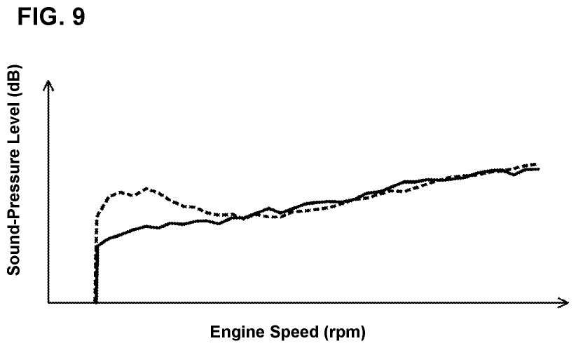

Verification tests to verify suppression effects of the radiation noises were conducted by using the engine to which the present invention is applied. An example of results of the verification tests is shown in FIG. 9.

A lateral axis means an engine speed and a vertical axis means a sound-pressure level (dB). Measuring results of the sound-pressure level of the radiation noises generated at the intake manifold in a range of the general engine speed are shown. A solid line shows the measuring results in a case where the damper plate is clamped (example). A broken line shows the measuring results in a case where the damper plate is not clamped (comparative sample).

While no substantial difference was recognized in a range of a middle speed through a high speed, the example showed greater decrease of the sound-pressure level compared to the comparative sample in the low-speed range. That is, it was confirmed that the radiation noises of the intake manifold could be suppressed effectively by application of the present invention.

The present invention is not limited to the above-described embodiment but any other medications can be applied.

For example, while the present embodiment exemplifies the case where the “EGR system” corresponds to the EGR valve, the present invention is not limited to this. Similarly to the EGR valve, the damper plate may be arranged between the EGR cooler and the intake manifold as well, and these both may correspond to the “EGR system.”

Further, only the EGR cooler may correspond to the “EGR system” in place of the EGR valve. In particular, this is useful that the EGR cooler is arranged at a position which is further from the engine body than the EGR valve.

The structure of the engine of the present embodiment is changeable properly according to design. The engine may be a diesel engine.

What is claimed is:

1. An intake device of an engine which is installed to a vehicle, comprising:
an intake manifold attached to an upper portion of an engine body including a cylinder block and a cylinder head which is provided on an upward side of the cylinder block and introducing intake air into the engine body; and
an EGR system comprising at least one of an EGR cooler and an EGR valve, the EGR cooler being configured to cool EGR gas recirculated from an exhaust passage of the engine to the intake manifold, the EGR valve being configured to adjust the amount of flow of the EGR gas,
wherein said EGR system is arranged at a specified position above said intake manifold, a pair of facing surfaces which face each other with a specified space are provided at a lower portion of the EGR system attached to the intake manifold and an upper portion of the intake manifold, a damper plate having elasticity is arranged between said pair of facing surfaces, said damper plate is configured to have a larger thickness than said space and have a smaller Young's modulus than each of a lower-side facing-surface portion of said intake manifold and an upper-side facing-surface portion of said EGR system which respectively said pair of facing surfaces, and said damper plate is clamped between said lower-side facing-surface portion of the intake manifold and said upper-side facing-surface portion of the EGR system.

2. The intake device of the engine of claim 1, wherein plural reinforcing ribs are formed on a surface of a part of said intake manifold which is positioned around said lower-side facing-surface portion of the intake manifold, and the lower-side facing-surface portion of the intake manifold is configured to be a smooth surface with no rib.

3. The intake device of the engine of claim 2, wherein a lower surface of said upper-side facing-surface portion of the EGR system is formed in an uneven shape, and an upper surface of said damper plate is formed in an uneven shape which is fit into said uneven shape of the lower surface of the upper-side facing-surface portion of the EGR system.

4. The intake device of the engine of claim 3, wherein said space is smaller than a height of said rib.

5. The intake device of the engine of claim 1, wherein said EGR system is attached to said intake manifold by fastening of plural fastening portions, said plural fastening portions include a first fastening portion, a second fastening portion which is further separated from said engine body than said first fastening portion, and a third fastening portion which is closer to the engine body than said second fastening portion and laterally offset from a longitudinal direction on which said first fastening portion and said second fastening portion align, and a central portion of said damper plate is positioned in an area which is enclosed by said first fastening portion, said second fastening portion, and said third fastening portion.

6. The intake device of the engine of claim 1, wherein said intake manifold comprises an upstream portion which extends in the longitudinal direction at a position which is separated from a side face of said engine body and a downstream portion which expands in a lateral direction from an upper end part of said upstream portion and is attached to the side face of the engine body, an intercooler to the intake air is arranged in a space below said downstream portion, and said lower-side facing-surface portion of the intake manifold is provided at a position of the downstream portion which is separated from the engine body.

7. The intake device of the engine of claim 6, wherein said EGR system is said EGR valve, the EGR valve comprises a valve body to adjust the amount of flow of the EGR gas by opening/closing of the valve and a valve adapter which has a flow passage where the EGR gas flowing out of said valve body is introduced and is integrated with said valve body and attached to the intake manifold, and said upper-side facing-surface portion of the EGR system is constituted by a lower portion of said valve adapter.

8. An assembling method of an intake device of an engine installed to a vehicle, in which an engine body of the engine includes a cylinder block and a cylinder head which is provided on an upward side of the cylinder block and an EGR system comprising at least one of an EGR cooler and an EGR valve is attached to a specified position above an intake manifold attached to the cylinder head of the engine, the assembling method comprising:
an arrangement step of arranging a damper plate in a space which is formed between a lower-side facing-surface portion provided at an upper portion of the intake manifold and an upper-side facing-surface portion provided at the EGR system which face each other when the EGR system is attached to the intake manifold, wherein said damper plate is configured to have a larger thickness than said space and have a smaller Young's modulus than each of said lower-side facing-surface portion of the intake manifold and said upper-side facing-surface portion of the EGR system; and
a clamping step of clamping said damper plate between said lower-side facing-surface portion of the intake manifold and said upper-side facing-surface portion of the EGR system by attaching the EGR system to the intake manifold.

9. The assembling method of the intake device of the engine of claim 8, wherein said EGR system is attached to said intake manifold by fastening of plural fastening portions, said plural fastening portions include a first fastening portion, a second fastening portion which is further separated from said engine body than said first fastening portion, and a third fastening portion which is closer to the engine body than said second fastening portion and laterally offset from a longitudinal direction on which said first fastening portion and said second fastening portion align, and said damper plate is arranged in said arrangement step such that a central portion of the damper plate is positioned in an area which is enclosed by said first fastening portion, said second fastening portion, and said third fastening portion.

10. The intake device of the engine of claim 2, wherein said space is smaller than a height of said rib.
